(19) United States
(12) Patent Application Publication
(10) Pub. No.: US 2023/0230177 A1
(43) Pub. Date: Jul. 20, 2023

(54) RELATIONSHIP APP FACILITATING IN-PERSON INTERACTION

(71) Applicant: George A. Pazdral, II, Giddings, TX (US)

(72) Inventor: George A. Pazdral, II, Giddings, TX (US)

(21) Appl. No.: 17/579,176

(22) Filed: Jan. 19, 2022

(51) Int. Cl. G06Q 50/00; G06Q 30/02; G06Q 10/10; G06Q 20/38; G06Q 20/10

(52) U.S. Cl. CPC G06Q 50/01; G06Q 30/0203; G06Q 10/1095; G06Q 20/384; G06Q 20/102

(57) ABSTRACT

An online dating service provides matchmaking by finding a relationship match based on a comparison of preferences of one person to personal information of the other, and a compatibility score derived by comparing answers of the two persons to several surveys. The interested person can set a threshold value for the compatibility score to cull low-compatible matches, and can view a match's answers to decide if they want to proceed with an in-person meeting. Once both parties agree, an invitation is sent to set up the in-person meeting by asking each party to pay a one-time fee. If both parties confirm the invitation, the server debits their accounts and enables a date setup protocol. That protocol automatically selects one of the parties as a date initiator based on their genders and indications from each of them as to whether or not they want to decide the date details.

### BACKGROUND OF THE INVENTION

### Field of the Invention

The present invention generally relates to relationship programs or services (e.g., dating apps), and more particularly to a method of using an online service to facilitate expedited offline interactions.

### Description of the Related Art

With the advent of the Internet and technologies like smartphones that enable simplified access to computing services, a variety of computer applications (apps) have arisen to enhance social interactions and particularly relationship opportunities, such as online dating sites. Online dating sites generally allow a user to enter limited personal information that others can see, and that user can also see information regarding other people who have signed up with the service. Some dating sites allow the user to search records to try and find a match based on certain personal preferences. Once a user has found someone else they are interested in, they can send a notification to the other person and if both parties are interested, further action can be taken. This may include for example sharing other contact information, i.e., external to the dating site, or setting up a virtual date where the two parties can meet online in a video chat or watch a virtual movie together.

Dating services use different approaches to monetize this connecting of interested individuals. One of the most common is paid memberships which has the advantage of discouraging impulse matching, i.e., folks who pay ahead of time for the service are seen as more serious about establishing a relationship. A user initially pays a subscription fee for say a year and during that time they are able to scan any other members of the service to see if someone looks interesting. There are however a variety of other approaches that do not require prepaid memberships. These include a simple advertising approach where users of the website or app are periodically presented with third party advertisements, an affiliate strategy where offers are made to the users from various businesses relevant to the dating industry or a particular niche of the dating site, gifting opportunities where one user is allowed to send gifts to another user whether they are virtual gifts (e.g., an electronic greeting card) or tangible items that are delivered, premium/VIP offerings, and sponsored live events.

### SUMMARY OF THE INVENTION

The present invention in at least one embodiment is generally directed to a method carried out by a computer server for facilitating a relationship between an interested person and a responding person by determining that the interested person and the responding person constitute a potential relationship match based on both (i) a comparison of preferences of the interested person to personal information of the responding person, and (ii) a compatibility score derived by comparing a first set of answers of the interested person for several surveys to a second set of answers of the responding person for the same surveys. In some implementations the interested person can set a threshold value for the compatibility score to cull low-compatible matches. The interested person can view the responding person's matching information including the responding person's answers to the surveys and decide if they want to proceed with a request for an in-person meeting, in which case the server transmits a request to the responding person along with matching information for the interested person including the interested person's answers to the surveys. Once the server receives an affirmative response to the request from the responding person (indicating approval of the in-person meeting), it transmits an invitation to both parties to set up the in-person meeting by paying a one-time fee. If both parties confirm the invitation, the server debits their respective monetary accounts by an amount equal to the fee, and enables a date setup protocol. That protocol automatically selects one of the parties as a date initiator based on their genders and indications from each of them as to whether or not they want to decide the date details. In one implementation, the selection is biased in favor of the female party so if she wants to decide the date details then she is allowed to do so regardless of whether the male party wants to or not, and if she does not want to decide then the male party is selected as date initiator even if he indicates that he does not want to decide. The server will prompt the selected date initiator to proposed date details, which can be transmitted to the other party for their approval.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a block diagram of a computer system programmed to carry out a dating service in accordance with one implementation of the present invention;

FIG. 2 is a block diagram of a mobile computing device (e.g., smartphone) programmed to carry out a dating app in accordance with one implementation of the present invention;

FIG. 3 is a pictorial diagram of a computing environment which includes the computer system of FIG. 1 and the mobile computing device of FIG. 2 in accordance with one implementation of the present invention;

FIGS. 4A-4D are screenshots of a smartphone illustrating various user interfaces that are presented to a user in setting up a user profile for a dating service in accordance with one implementation of the present invention;

FIGS. 5A-5C are screenshots of a smartphone illustrating various user interfaces that are presented to a user as part of a date matching process in accordance with one implementation of the present invention;

FIG. 6 is a chart illustrating the logical flow for a dating app process in accordance with one implementation of the present invention;

FIG. 7 is a chart illustrating the logical flow for a high-level dating service process carried out by a computer server in accordance with one implementation of the present invention;

FIG. 8 is a chart illustrating the logical flow for a matching process carried out as part of the high-level dating service process of FIG. 7 in accordance with one implementation of the present invention;

FIG. 9 is a chart illustrating the logical flow for an introduction process carried out as part of the high-level dating service process of FIG. 7 in accordance with one implementation of the present invention;

FIG. 10 is a chart illustrating the logical flow for a date setup process carried out as part of the high-level dating service process of FIG. 7 in accordance with one implementation of the present invention.

The use of the same reference symbols in different drawings indicates similar or identical items.

### DESCRIPTION OF THE PREFERRED EMBODIMENT(S)

Even with the plethora of dating services that are currently available, it can still be difficult for someone to find another person that they can establish a long-term relationship with. One drawback is how many dating apps do not really facilitate in-person meetings, e.g., a “first date”, but rather tend to keep people occupied with the smartphones or other electronic devices. They are not geared towards getting people into relationships because they are more interested in having people spend money by staying more engaged with the app. It would, therefore, be desirable to devise an improved dating app that not only provides quality matching services for people looking for serious relationships, but also facilitates in-person interaction by skipping unnecessary formalities and getting right to setting up the first date. It would be further advantageous if the method could allow users to explore in a variety of ways how a potential match might be compatible. These and other advantages are achieved in various implementations of the present invention by getting basic personal information from users as well as their stances on things like smoking, drinking, religion, politics, etc., and having them complete multiple surveys on different identifiable topics. The survey answers help establish a compatibility score which is used in conjunction with the other preferences to determine possible matches. If a user is interested in one of the candidates then that person is alerted and once both users agree, they are presented with the chance to pay some amount to set the first date, e.g., the place and time or other details. To additionally facilitate the process, the invention further contemplates a date setup protocol which automatically prompts a selected one of the two persons to propose date details based on their desire to make this decision as well as their respective genders.

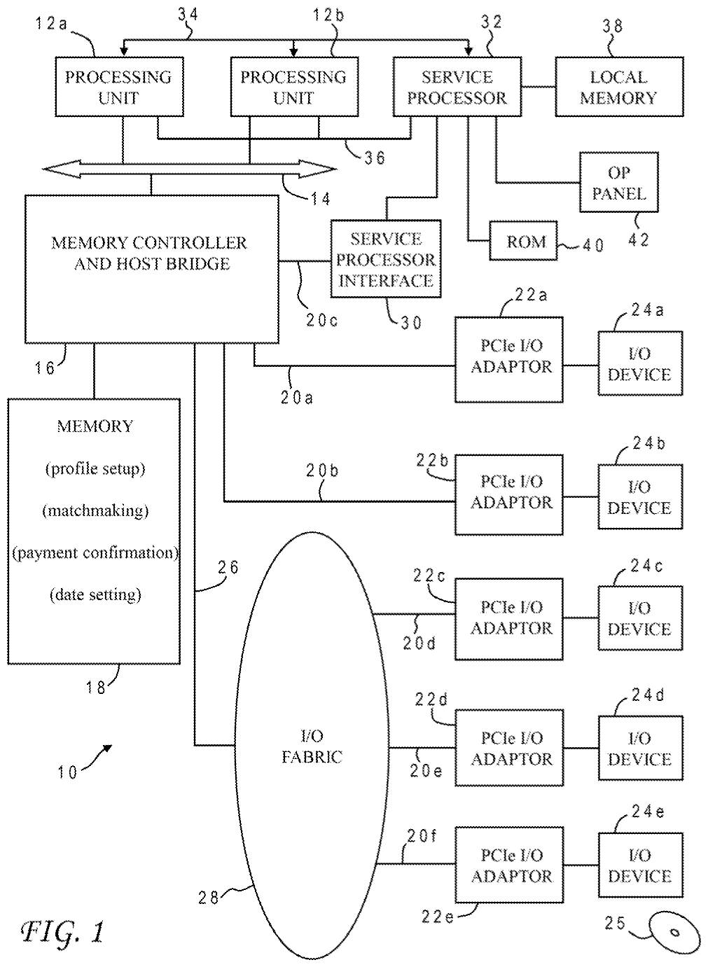

With reference now to the figures, and in particular with reference to FIG. 1, there is depicted one embodiment 10 of a computer system in which the present invention may be implemented to carry out a relationship service (e.g., dating app) to facilitate in-person interactions between two people. Computer system 10 is a symmetric multiprocessor (SMP) system having a plurality of processors 12a, 12b connected to a system bus 14. System bus 14 is further connected to and communicates with a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches. System memory 18 has loaded therein one or more applications or services in accordance with the present invention. In this implementation those include a profile setup service, a matchmaking service, a payment confirmation service, and a date setting service.

MC/HB 16 also has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f. These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive which receives an optical disk 25 (one example of a computer readable storage medium) such as a CD or DVD, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention. The invention may further be implemented in an equivalent cloud computing network.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the dating service of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

The present invention may be a system, a method, and/or a computer program product. The computer program product may include one or more computer readable storage media collectively having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer system 10 carries out program instructions for a dating service that uses novel matching, payment and dating techniques to manage in-person interactions. Accordingly, a program embodying the invention may additionally include conventional aspects of various dating service tools, and these details will become apparent to those skilled in the art upon reference to this disclosure.

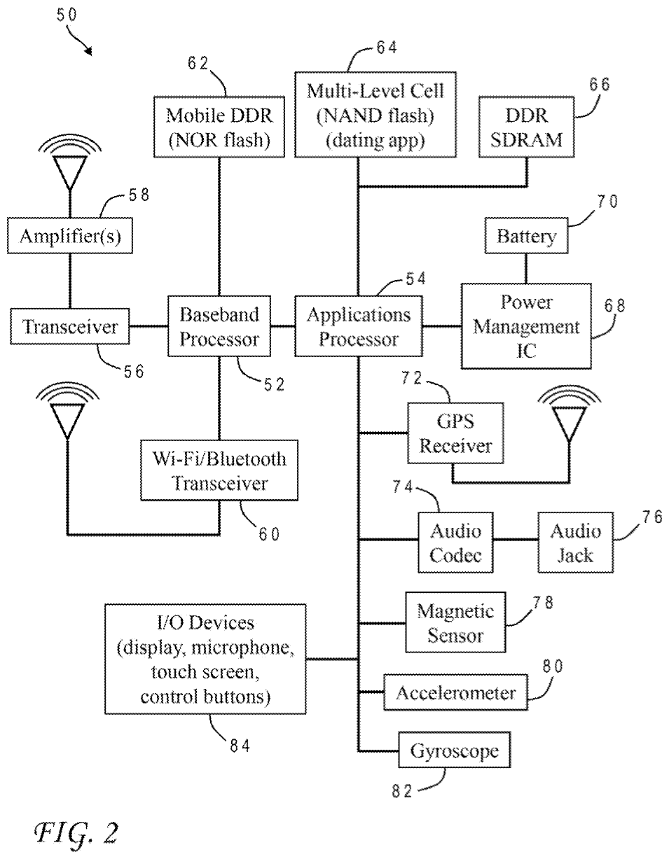

Referring now to FIG. 2, there is depicted one example 50 of a mobile computing device or smartphone in which embodiments of the present invention may be implemented to carry out a dating app by an end user, i.e., someone who is interested in finding a date or other relationship. As with computer system 10, alternative embodiments of smartphone 50 may include modifications of the hardware components or their interconnections, or additional components, and other mobile computing devices may be used besides smartphones such as tablets or notebooks, so the depicted example should not be construed as implying any architectural limitations with respect to the present invention. In this example smartphone 50 includes a baseband processor 52 and an applications processor 54. Baseband processor 52 manages most of the radio (wireless communications) functions of smartphone 50, including communication with a wireless service provider (including Internet transmissions) via a transceiver 56 which is connected by one or more power amplifiers 58 to a network antenna. Baseband processor can also control Wi-Fi and Bluetooth transmissions through transceiver 60 connected to a local antenna. Baseband processor 52 uses a dedicated mobile DDR memory (NOR flash) 62.

Baseband processor 52 essentially acts as an input/output (I/O) device with respect to applications processor 54 which executes the software programs (apps) embodying the invention. Those applications may include one or more programs that can also be carried out by computer system 10. Applications processor 54 preferably utilizes multi-level cell memory (NAND flash) 64 and DDR synchronous dynamic random-access memory (SDRAM) 66. In particular, NAND flash 64 may store a dating application of the present invention. Applications processor 54 can interact with a power management integrated circuit 68 to control the power supply (battery) 70. Applications processor 54 can additionally receive inputs from a variety of peripheral devices such as a global positioning satellite (GPS) receiver 72 connected to a GPS antenna, an audio codec 74 which drives an audio (e.g., headphone) jack 76, a magnetic sensor 78 for azimuthal indication, an accelerometer 80 for crash detection and prevention, a 3-axis gyroscope 82 for orientation indication, and user I/O devices 84 (e.g., touch screen/display, microphone and control buttons). Smartphone 50 may include many other hardware features not illustrated, for example, a camera and associated driver circuitry.

When smartphone 50 is first turned on, baseband processor 52 and applications processor 54 may perform various tests such as built-in-self-tests or memory tests on the memory components 62, 64, 66. If the systems pass the tests then each processor begins execution of its primary code, namely, a communications link for baseband processor 52 and an operating system for applications processor 54. Once the network communications have been established by baseband processor 52 and the operating system is loaded by applications processor 54, the user can enter appropriate commands via the touch screen or microphone to load executable code representing embodiments of the present invention for execution by applications processor 54. Any or all of the functionalities of computer system 10 can be incorporated directly into mobile device 50 as computing power and memory storage permit.

Those skilled in the art will understand that in the exemplary implementation the dating service is accessed via a smartphone app but it could be implemented in other manners such as operated on a website accessed via a different electronic device like a desktop computer or run as a standalone program on a desktop computer accessing a web service.

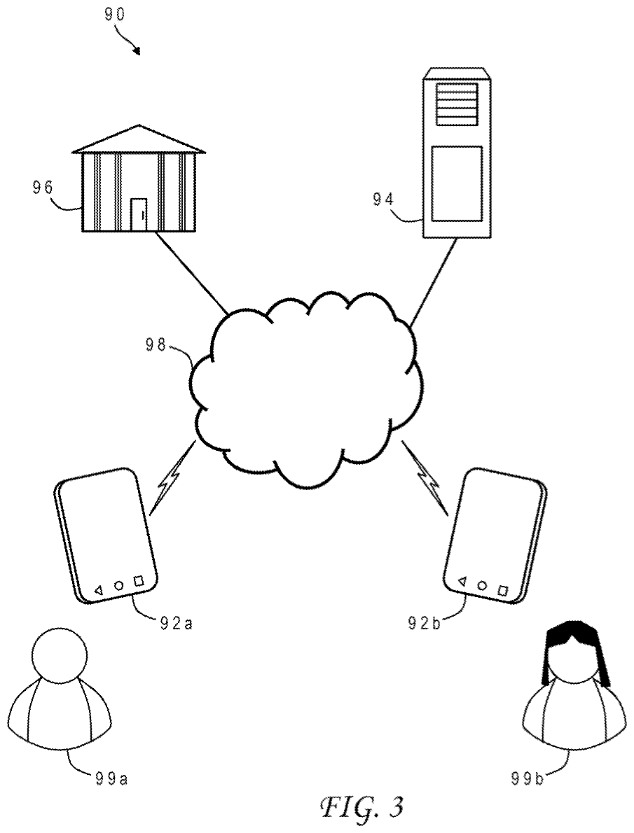

The invention is preferably practiced in a networked computing environment. FIG. 3 depicts an appropriate computing environment 90 according to an illustrative implementation. Computing environment 90 includes multiple nodes 92a, 92b, 94 and 96 which selectively communicate with one another via a network 98, e.g., the Internet. Nodes 92a, 92b are smartphones such as that described in conjunction with FIG. 2, and are respectively operated by two users 99a, 99b who are interested in finding a relationship match. Consistent with the foregoing paragraph, nodes 92a, 92b could be other local computing devices used by consumers, for example, a personal digital assistant, desktop computer, laptop computer, or automobile computer system. Node 94 is a computer server that supports the dating service and may be implemented with the structure seen for the computer system of FIG. 1. Node 96 is a monetary service such as a financial institution (e.g., bank or credit card company) or other payment company (e.g., Venmo or PayPal). Computing environment 90 may include many other nodes not shown, and any given node may further be grouped physically or virtually in one or more other networks, such as private, community, or public, or a combination thereof. It is understood that the types of computing devices shown in FIG. 3 are intended to be illustrative only and that computing environment 90 can allow communications with any type of computerized device over any type of network and/or network addressable connection (e.g., using a web browser). In some embodiments, one or more aspects of the present invention may be carried out using cloud computing although implementation of the teachings recited herein are not limited to a cloud computing environment. Rather, embodiments of the present invention are capable of being implemented in conjunction with any other type of computing environment now known or later developed.

As noted, smartphones 92a and 92b are enabled to communicate with server 94 over the Internet using any convenient interface, preferably a dating app, i.e., a distinct computer program that is designed to run on smartphones of various types in accordance with this disclosure (see NAND flash memory 64 in FIG. 2). They are also able to communicate with monetary service 96 to create and manage one or more monetary accounts from which money can be transferred, particularly to an account controlled by the operator of the dating service, i.e., server 94. Technically smartphones 92a and 92b could communicate with each other but in the exemplary implementation users 99a and 99b are unknown to one another prior to engaging in the matchmaking process and so are not in communication. Either user 99a, 99b could initiate the process using the app on their respective smartphone, but for purposes of illustration this implementation focuses on the perspective where user 99a is more interested in initiating the matching process (the “interested person”), and user 99b is taking a more passive role by responding to other peoples' interest (the “responding person”). However, those skilled in the art will appreciate that any of the actions described below as being carried out by either of these two persons could likewise be carried out by the other person in a different context. Further to this example, and only for purposes of simplicity, user 99a is a man and user 99b is a woman. In this regard, the disclosure refers to a “gender” of a person but this term is not necessarily considered a binary matter and could extend to other gender identities, such as gay man, lesbian women, trans man, trans woman, bisexual, or nonbinary depending upon implementation design details, so the this term should not be construed in a limiting sense.

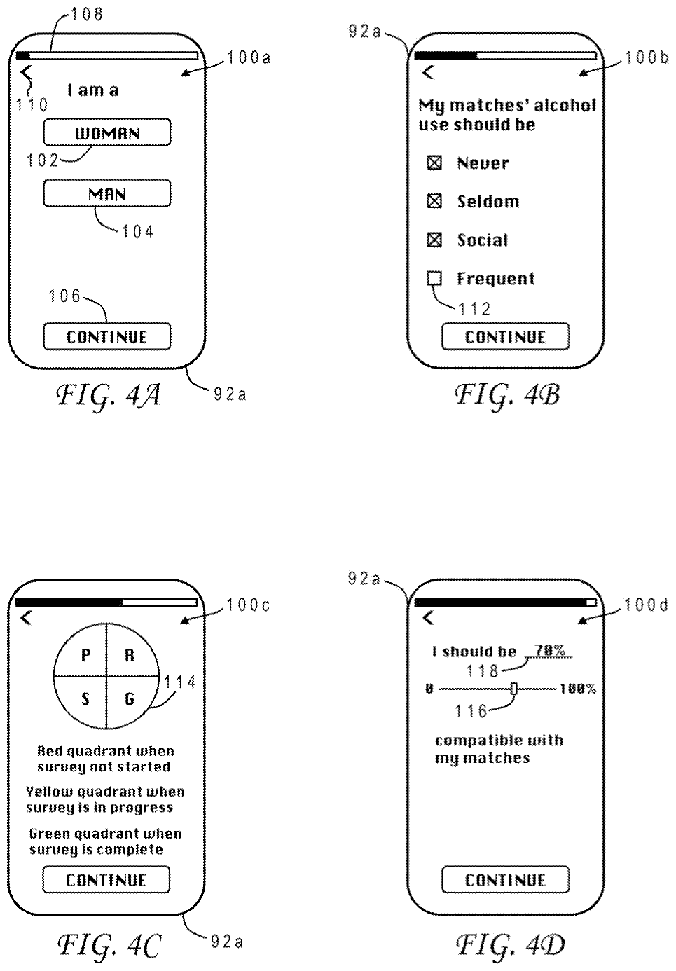

The matchmaking process described herein can be considered as having two phases, first the actions that lead up to finding a potential match, and then steps taken after a potential match is found to expedite the in-person interaction. FIGS. 4A through 4D pertain to the first phase, and are screenshots of an electronic device of the interested person, e.g., smartphone 92a, illustrating various user interfaces that are presented to the interested person to set up a user profile in accordance with one implementation of the present invention. The user interfaces include information and requests transmitted by server 94 or provided from the local dating app, as well as various interactive objects including buttons, check boxes, sliders or other features that can be activated by the user in various means, such as tapping or dragging an area of a touch screen. The user would first create an account with the dating service in a typical fashion such as by entering basic information like a login name, first and last real names, password or other authentication, and email address or phone number; this basic account information is not used in the matchmaking process, it is only for enabling communication with the dating service. Account creation/login could be performed by linking third-party credentials, e.g., Apple, Facebook or Google.

The user also enters other personal information relevant to the anticipated relationship. The personal information is in the nature of physical or demographic information of the person themself, not preferences regarding potential dating candidates, and are basically factual matters. For example the user will indicate their own gender first as seen in an exemplary user interface 100a of FIG. 4A. User interface 100a includes a “WOMAN” button 102, a “MAN” button 104, and a “CONTINUE” button 106. As noted above, other implementations may allow for additional gender selections. After the user has selected one of buttons 102 or 104, when button 106 is activated the user interface will progressively ask for other information in a similar fashion including but not limited to the user's age, height, weight, hair color, race or ethnicity, education level, religion (which could include agnostic or atheist), locality, drinking habits, smoking habits, plans for children, political affiliation, etc. Most of these questions will be close-ended or limited (e.g., a distance measure for length), but freeform information can also be solicited such as a brief biography. The dating app can further allow multiple photos or videos of the user to be uploaded to their profile. User interface 100a (as well as the other user interfaces described further below) may include a variety of other features. In this example there is a progress bar 108 at the top of the screen showing how far along the user is in the matchmaking process, and a back button 110 which allows the user to exit out of the current interface and return to the previous screen.

After entering the personal information, the user enters their preferences regarding other users, i.e., potential matches. Preferences can be indicated for any or all of the corresponding personal information that was entered for the user, e.g., an acceptable age bracket for a match, restrictions on drinking habits, etc. In other words, the responding person will have entered personal information in a similar manner, and the preferences of the interested person will be matched against the personal information of the responding person. In an alternative embodiment, the preferences can be entered as part of the same process that gathers the user's personal information, i.e., in a side-by-side fashion where the user answers both a question a question about themself and the same question about a prospective match. The user can be presented with the option to select more than one static criterion for a given preference. For example, as seen in user interface 100b of FIG. 4B, the dating app might allow a given person to indicate that their alcohol use is one of four levels: never, seldom, social or frequent. The user is then presented with four check boxes 112 for each of these levels and can select each check box independently. So in the example of FIG. 4B, user 99a has indicated that he would be ok with a match whose alcohol use was never, seldom or social, but not frequent. Again, when the continue button is activated the user interface will progressively ask the user for other match preferences in a similar fashion. The sum total of all of the preferences can be used as initial mandatory requirements in finding a list of suitable relationship candidates. In some implementations, a potential match may be allowed even if it is established that not all of the preferences are satisfied by the responding person's personal information. In some implementations, the user is allowed to create one set of preferences for potential romantic matches, and a separate set of preferences for potential platonic matches. In this regard, the term “date” as used herein could refer to a romantic date or a platonic date. A single dating app could be set up to accommodate both types of matching, or the platonic option could be implemented in a separate app.

After entering the matching preferences, the user takes several surveys on different identifiable topics. As opposed to the factual matters in the user's personal information, the surveys are directed to more subjective matters. Also, unlike the indicated preferences, survey answers do not create a mandatory matching requirement but rather are used as described further below to generate a compatibility score which is a separate factor in the matchmaking procedure. In the illustrative implementation, and as seen in user interface 100c of FIG. 4C, there are four surveys on the topics of personality traits (“P”), social practices (“S”), recreational pursuits (“R”), and future goals (“G”). User interface 100c includes an interactive object 114 in the form of a circle divided into multiple sectors or quadrants, one for each topic. If the user taps on one of these quadrants, they are presented with additional screens having various survey questions for the particular topic selected, and the user provides answers to each of those questions. Questions for the personality trait survey may for example include whether the user is more introverted or extroverted, more left-brained or right-brained, more punctual or less so, more “workaholic” or less so, and whether they are a dog or a cat person. Questions for the social practices survey may for example include whether the user has many close friends, seeks out people who are similar to them, worries about being alone, and whether they want emotionally close relationships. Questions for the recreational pursuits survey may for example include whether the user prefers to do activities by themself, whether the user leads an active lifestyle, whether the user reads for fun, and whether being in nature brings the user pleasure. Questions for the future goals survey may for example include whether the user aspires to live in the city or the country, aspires to have no kids or to have them, prefers short term goals or long term goals, and wants to speak another language or not. Answers can be multiple choice. As explained by the comments seen in FIG. 4C, a color-coding scheme may be employed to prompt the user through the surveys, where a given quadrant will be red colored if that survey has not yet been started, or will be yellow colored if that survey has been started but not completed, or green colored if that survey is complete. The user may still be allowed to go back at any time and change the survey answers if their views have changed.

It may be noted that a user's desire to have or not have children might be considered a future goal, but this point may be deemed critical to many users so in this implementation it is presented as personal information (i.e., part of the mandatory matching scheme), although a user might indicate in their personal profile that this point is unimportant to them, i.e., in the entry of this piece of personal information a user could indicate that they want children, they don't want children, or they don't care. The same point may be made for political affiliations which might be considered a social practice rather than personal information. This distinction (mandatory preference versus survey compatibility) is a matter of choice for the dating app designer.

In this manner, the user has now entered (i) their own personal information, (ii) their preferences for finding matches, and (iii) their own survey answers. These three categories of data may be entered in any order, not just that presented herein in conjunction with FIGS. 4A through 4C. Additional information may be gathered for the user as well.

The interested person's survey answers are compared to the survey answers of a potential match (i.e., the responding person) to compute a compatibility score. In a simplified example, the compatibility score is calculated as a percentage based on the number of survey answers from each person that match, i.e., the answers are identical. For example, each of the four surveys could have 25 questions, for a total of 100 questions, and the compatibility score is the total number of questions which were answered the same by both parties. The dating app could optionally weight answers from different surveys depending on the user, e.g., a user could indicate that social practices of a potential match are more important than the other survey facets in which case answers from the social practices survey would be given an increased value in the compatibility score computation, e.g., a value of 2 rather than 1, or a user could indicate that answers from the future goals survey are unimportant in which case a matching question would provide a value of ½ rather than 1.

In the preferred embodiment, the dating app allows a user to set a threshold value for the compatibility score to act as a cutoff in finding acceptable matches. FIG. 4D shows a user interface 100d that includes a slider bar 116 for setting the threshold, and the selected value is displayed in a text field 118 for confirmation. This culling takes place in addition to the preference matching, i.e., the dating app will only present a final match when it meets the preferences criteria and establishes that the compatibility score is at least as great as the threshold. The server providing the computations for the matching process preferably generates an initial set of candidates based on the preferences and then applies the compatibility threshold although other approaches could be implemented. If the final set of matches is relatively small, the user can back up in the process and reset the compatibility threshold to a lower value which will likely generate additional matches. So, for example, the matching service might look for women that are 25 years old, Christian, and don't smoke (all from preferences), and have at least a 70% compatibility score match (from survey answers). The user can then view a list of the final candidates and select one for further consideration.

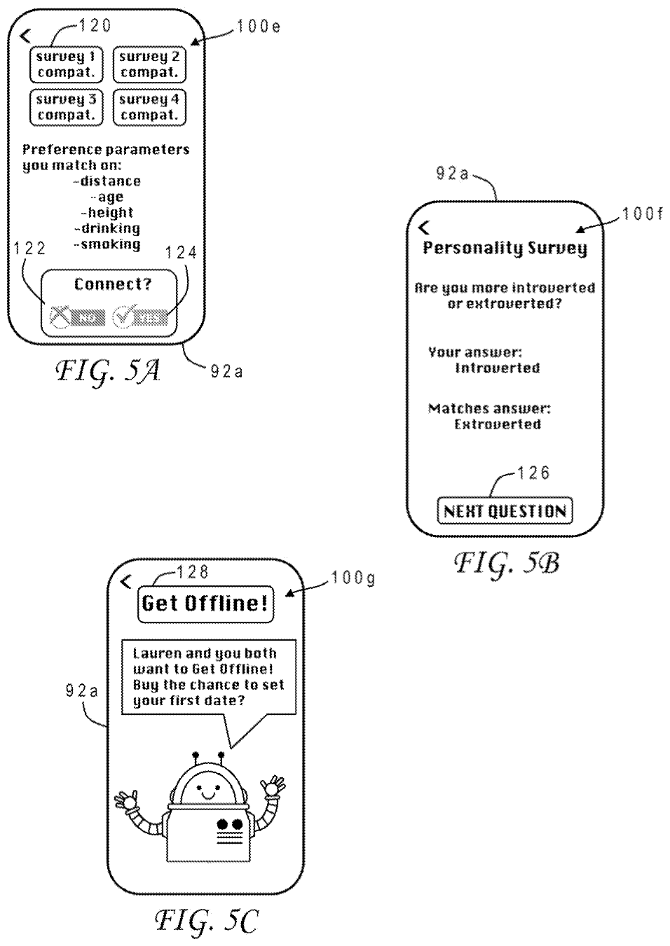

FIGS. 5A through 5C pertain to the second phase after a potential match has been so found, and are again screenshots of smartphone 92a in accordance with one implementation of the present invention. A user interface 100e in FIG. 5A shows summary screen for a given final match that has been selected by the user from the list, indicating which preference parameters were matched for this candidate. The listed parameters may include some that were not necessarily part of the required preferences; in the example of FIG. 5A the interested person might require only that the match be a woman of a certain age who lives within a certain distance but it turns out they additionally match in height, drinking habits, and smoking habits. Several buttons 120 are provided to allow for further inspection of survey compatibility. Activating a button 120 leads to a series of user interfaces such as 100f in FIG. 5B which allow the user to see side-by-side comparisons of the survey answers. In the example of FIG. 5B the user can see that his answer to a personality trait survey question was that he is more introverted, while the matching candidate' s answer was that she is more extroverted. When the “NEXT QUESTION” button 126 is activated, the screen progressively reveals the other questions for the particular survey selected. Summary screen 100e might optionally show separate compatibility percentages for each survey to provide further insight for the possible match.

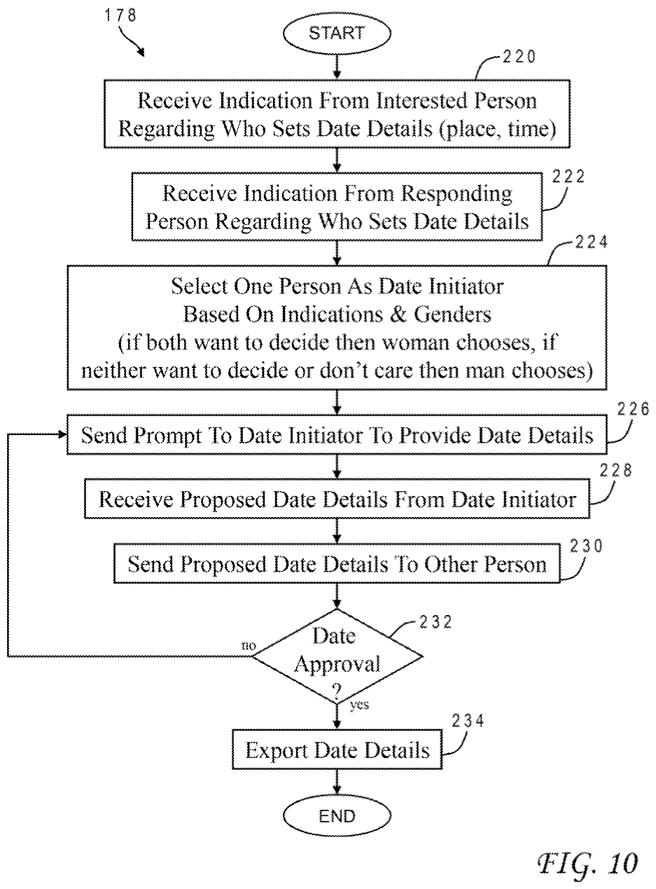

Returning to FIG. 5A, after the user has examined the survey answers, he can decide whether or not to connect with the match. Two selection objects 122, 124 are provided to allow the user to decline the suggestion or to make a connection. If the user decides to try and connect, the dating service will send a request notification to the match, i.e., to smartphone 92b. The match will be given the same opportunity to view matching preferences and survey compatibilities in a screen similar to FIG. 5A, with a similar option to decline or accept the connection. If the match agrees, both parties are notified and invited to consummate the connection by paying a fee as seen in user interface 100g of FIG. 5C. For example, if the responding person's name is Lauren, the invitation to the interested person may say “Lauren and you both want to Get Offline! Buy the chance to set your first date?”. If the interested person is so willing, he can activate a confirmation button 128 which in this example says “Get Offline!”. Once both users have so confirmed payment, the dating service can further facilitate the in-person interaction (e.g., a first date) by deploying a date setup protocol which automatically prompts a selected one of the two persons to proposed date details as described further below in conjunction with FIG. 10. Payment requirements can vary. In the illustrative implementation each person must pay the same, one-time fee. The users are given some period of time, say a week, to confirm the invitation to pay. Both users must pay for the program to move forward to setting the date. If only one user pays, their money is held in escrow and returned after the offer period expires without the other paying.

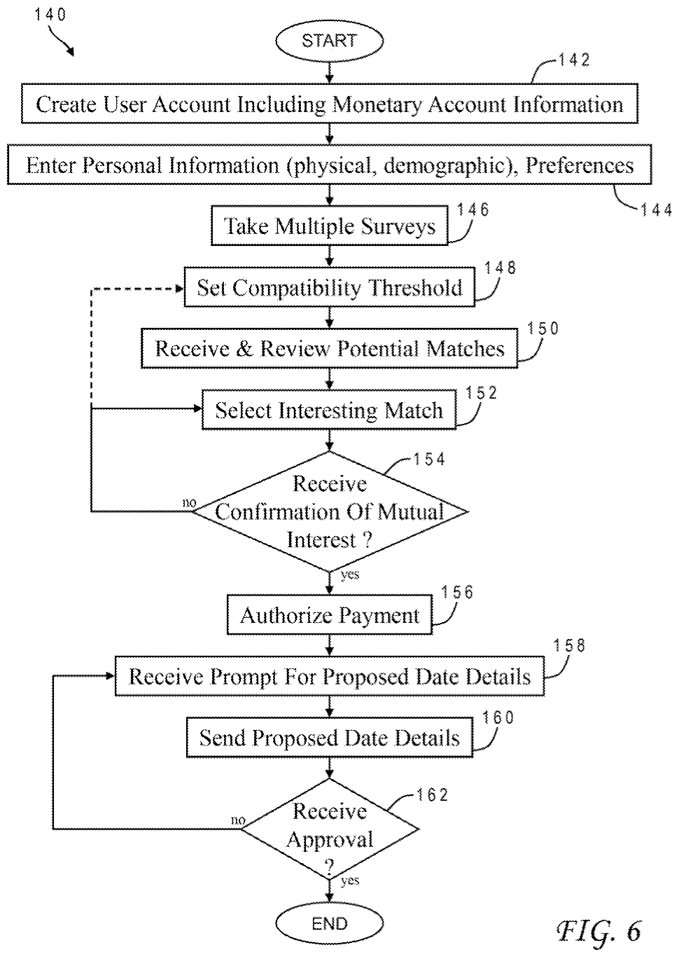

The present invention may be further understood with reference to the chart of FIG. 6 which shows the logical flow for a dating app process 140 from the user's perspective in accordance with the foregoing implementation. Process 140 begins with the user creating an account 142 on the dating site. As noted above, this includes entering basic identity and contact information, and preferably additionally includes providing information regarding a monetary account controlled by the user to enable the payment scheme. This may involve providing a credit card number, PayPal account information, etc. There may be other steps not shown such as asking the user to confirm their adherence to particular rules or a code of conduct for the dating site. The user also enters their own personal information as described above, and preferences regarding other users' for matching purposes 144. The user can then take the surveys on various topics 146, and set a desired compatibility threshold for initial screening 148. The dating service will generate a list of potential matches as described above, and send that to the user's electronic device, whereupon the user can review the matches 150 and select one they are interested in 152 (per FIGS. 5A and 5B). The dating service notifies the other party and forwards their response to the user. If the other party is not interested 154, the user can select another match for consideration returning to box 152, or alternatively can reset the compatibility threshold restarting the process at box 148. Once mutual interest has been confirmed, the dating service will prompt the user for the payment to initiate the date setup protocol, and according to this example the user agrees and thereby authorizes the payment 156. In some implementations the first match for a user might be free or discounted to a promotional rate. Further to this example, the dating service has selected this user (the interested person) as the date initiator so the user receives the prompt to setup the date by proposing a place and time or other details 158, and sends those details 160 to the server which forwards them to the responding person. If the details are not approved 162, the process return to box 158 to prompt the user for alternative date details. In responding to the date details, the responding person could optionally provide guidance in a one-way note, for example saying “the 19^{th} doesn't work for me, but the 18^{th} does”. Once the approval is received, the essential features of this implementation end insofar as the dating app is concerned, and the two persons can go on to meet in-person according to the prearranged details. Additional steps can be performed beyond those shown, such as the dating service posting the date details on a “Dates” page for the user, providing contact information to both users to enable direct communications without the involvement of the dating service, or exporting the date information to a calendar program for either or both users.

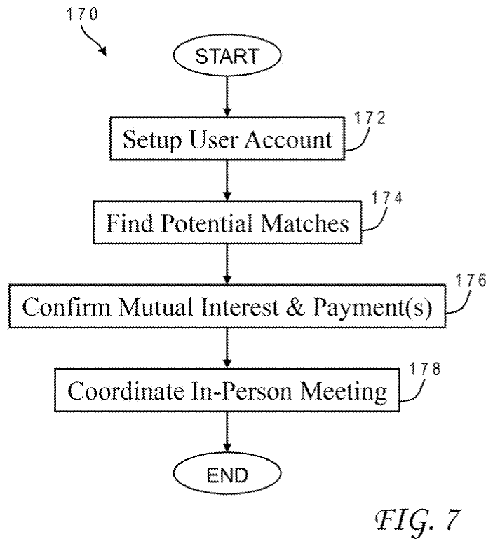

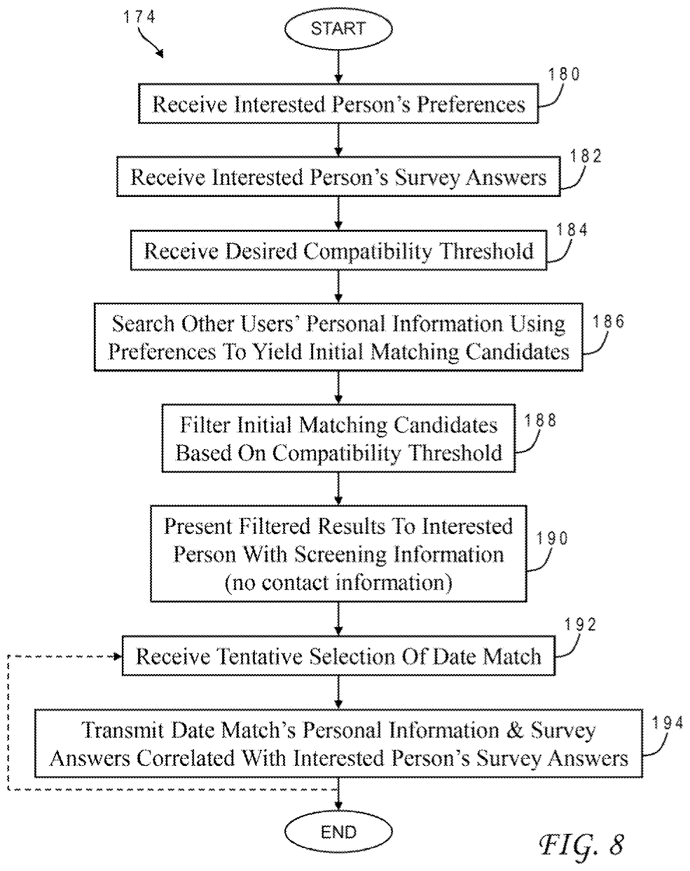

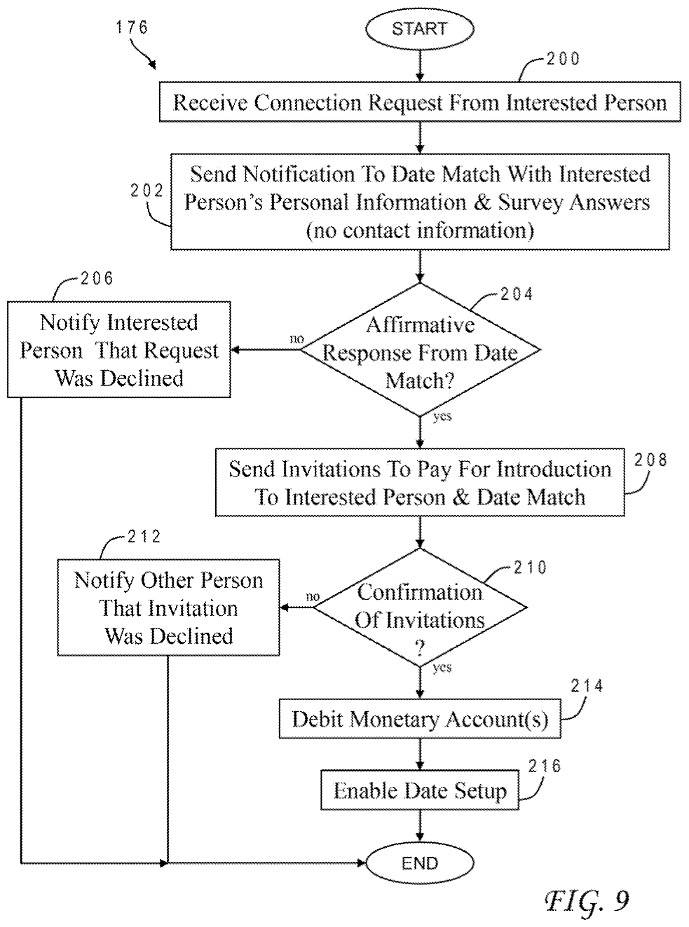

FIGS. 4A-4D, 5A-5C and 6 all pertain to the end user perspective, while FIG. 7 shows a corresponding high-level dating service process carried out from the perspective of the computer server in accordance with one implementation of the present invention. Process 170 similarly begins with the setup of the user's account 172. From the server side, this includes collecting the basic information (identity/contact) previously noted, as well as verifying payment information, i.e., the monetary account of the user, by contacting the relevant monetary service 96 using conventional means. Once the user has entered the remaining data (personal information, preference, and survey answers) the server will find potential matches 174 and send a list to the user. This function is described further below in conjunction with FIG. 8. The server will then receive a tentative selection from the user, and carry out the confirmation of mutual interest culminating with the user payment(s) to enable the date setup protocol 176. This function is described further below in conjunction with FIG. 9. Once payment by both parties is verified, the server begins the date setup protocol to coordinate the first in-person meeting 178. This function is described further below in conjunction with FIG. 10.

FIG. 8 shows details of the matching process 174 carried out by the server in accordance with one implementation of the present invention. Initially the server receives the interested person's preferences for matching 180, as well as their survey answers 182 and the desired compatibility threshold 184. The server will search its database of other user profiles to yield an initial set of matching candidates by comparing each member's personal information to the received preferences of the user 186 as described above for FIG. 4B. This initial set is further filtered based on the compatibility threshold 188 to cull low-compatibility matches, i.e., the survey answers for a given candidate in the initial set are compared to the user's survey answers to generate a compatibility score and only those scores equal to or greater than the threshold will pass through the filter. If no threshold was set by the user, a default value can be used, say 50%. The server then presents the filtered results to the interested person along with screening information 190, for each of the potential matches. The screening information is somewhat limited, such as providing just a name, age and photo of a potential match; no contact information for the potential match is provided to ensure compliance with the monetization scheme contemplated by the preferred implementation. More detailed information for a given candidate can be accessed by the interested person as described in conjunction with FIGS. 5A and 5B. Process 174 continues by presuming that the user finds one of the candidates interesting and the server accordingly receives that tentative selection for a date match 192, and transmits additional information regarding the date match to the user 194, i.e., the date match's personal information and survey answers correlated with the user's survey answers so they may be compared side-by-side by the user as seen in FIG. 5B. If the user is not sufficiently interested in the date match after reviewing this additional information, they may make another selection in which case the process returns to box 192 with a different candidate.

FIG. 9 shows details of the introduction process 176 carried out by the server in accordance with one implementation of the present invention. Process 176 begins with the receipt by the server of a request from the interested person to connect with a date match 200. The server will send a notification to the date match of the request 202, along with the personal information and survey answers of the interested person, so the date match can consider the interested person in the same manner. If the date match does not respond affirmatively 204, the server notifies the interested person that the request was declined 206 and the process ends (for this date match request). If the date match responds affirmatively, the server sends invitations to both parties for an introduction 208, indicating that payment is necessary at this point. If either party fails to pay (i.e., fails to accept the invitation), the server notifies the other person that the invitation was declined and the process ends (again, for this date match request). If both parties confirm the invitation, the server proceeds to debit the users' monetary accounts by the stated one-time fee, e.g., by making a charge to the users' credit cards. Once payment is verified, the server can enable the date setup protocol 216. If either the connection request was declined at 206 or the payment invitation was declined at 212 then the entire process 176 of FIG. 9 can be repeated with other potential date matches.

FIG. 10 shows details of the date setup process 178 carried out by the server in accordance with one implementation of the present invention. Process 178 presumes that the protocol has been enabled by previous payment of the one-time fee, per box 216 of FIG. 9. According to this protocol, one of the two persons is selected to propose details of a first date based on their inclinations and genders. Process 178 begins by receiving from the interested person an indication of whether they want to set the date details 222, and receiving a similar indication from the responding person 224. The indication can say that a party does want to decide, does not want to decide, or does not care (affirmative, negative, or neutral). The server can prompt the two parties for these indications after payment for setting up the first date has been made, or it can be part of initial information that the parties provide when setting up their member accounts with the dating service. The server then selects just one of the parties as a date initiator 224. The exact rules for this selection can vary according to the dating service designer. In the illustrative implementation where the two parties have different genders, the selection is biased in favor of the party that identifies as female so if the female party wants to decide the date details, she is allowed to do so regardless of whether the male party wants to or not. If the female party does not want to decide, the male party is selected as date initiator even if he indicates that he does not want to decide. The server sends a prompt to the selected date initiator informing them that they need to provide proposed date details 226, receives the proposed details from the date initiator 228, and forwards the proposed date details to the other person 230. If the other person does not approve the proposal 232, the process returns iteratively to box 226 to prompt the date initiator for alternative date details. Once the date is approved, the server can export the date details 234 as previously described.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, the selection of one party as the date initiator in the foregoing description is biased toward the female but there are many other approaches that are equally valid. It is therefore contemplated that such modifications can be made without departing from the spirit or scope of the present invention as defined in the appended claims.

1. A computer-implemented method carried out by a server for facilitating a relationship between an interested person and a responding person, comprising:
receiving from a first electronic device associated with the interested person first personal information on a plurality of subjects and first preferences relating to at least some of the subjects;
receiving from a second electronic device associated with the responding person second personal information on the plurality of subjects;
receiving from the first electronic device a first set of answers of the interested person regarding questions presented in a plurality of separate surveys each survey having a different identifiable topic;
receiving from the second electronic device a second set of answers of the responding person regarding the questions presented in the plurality of separate surveys;
computing a compatibility score using the first and second sets of answers;
determining that the interested person and the responding person constitute a potential relationship match based on the compatibility score and based on a separate comparison of the first preferences to the second personal information;
transmitting first matching information regarding the responding person to the first electronic device wherein the first matching information excludes any contact information for the responding person;
receiving a request from the first electronic device for an in-person meeting between the interested person and the responding person;
transmitting a request notification to the second electronic device with second matching information regarding the interested person wherein the second matching information excludes any contact information for the interested person;
receiving an affirmative response to the request notification from the second electronic device indicating approval of the in-person meeting by the responding person;
after receiving the affirmative response, transmitting an invitation to the first electronic device and to the second electronic device to set up the in-person meeting by paying a one-time fee;
receiving a first confirmation of the invitation from the first electronic device and a second confirmation of the invitation from the second electronic device;
responsive to receipt of the first and second confirmations, debiting a first monetary account associated with the interested person by an amount equal to the fee, and debiting a second monetary account associated with the responding person by an amount equal to the fee;
receiving from the first electronic device a first indication of whether the interested person wants to decide place and time of the in-person meeting;
receiving from the second electronic device a second indication of whether the responding person wants to decide place and time of the in-person meeting;
selecting only one of the interested person or the responding person as a date initiator based on the first indication, the second indication, a first gender of the interested person and a second gender of the responding person;
transmitting a prompt message to a selected one of the first or second electronic devices which is associated with the date initiator wherein the prompt message indicates that the date initiator is to provide proposed date details;
receiving proposed date details from the selected one electronic device of the date initiator;
transmitting the proposed date details to another of the first or second electronic devices which is not associated with the date initiator; and
receiving confirmation from the other electronic device indicating approval of the proposed date details.

2. The computer-implemented method of claim 1 wherein the first matching information includes the second set of answers and the second matching information includes the first set of answers.

3. The computer-implemented method of claim 1 further comprising receiving a compatibility threshold value selected by the interested person from the first electronic device, and wherein:
said computing includes calculating a percentage of the survey answers from the first set that are identical to the survey answers from the second set; and
said determining includes establishing that the compatibility score is greater than or equal to the compatibility threshold value.

4. The computer-implemented method of claim 1 wherein said determining includes establishing that each of the first preferences is satisfied by the second personal information.

5. The computer-implemented method of claim 1 wherein:
each of the first and second indications can be affirmative, negative, or neutral as to deciding place and time of the in-person meeting;
the interested person is a male party and the responding person is a female party; and
said selecting selects the female party as the date initiator when the second indication is affirmative, and selects the male party as the date initiator when the second indication is negative.

6. The computer-implemented method of claim 1 wherein:
the plurality of subjects comprise factual physical and demographic information including at least age, height, gender, locality, ethnicity and religion; and
the surveys include at least
a personality traits survey having multiple questions,
a social practices survey having multiple questions,
a recreational pursuits survey having multiple questions, and
a future goals survey having multiple questions.

7. A computer system comprising:
one or more processors which process program instructions;
a memory device connected to said one or more processors; and
program instructions residing in said memory device for facilitating a relationship between an interested person and a responding person by receiving from a first electronic device associated with the interested person first personal information on a plurality of subjects and first preferences relating to at least some of the subjects, receiving from a second electronic device associated with the responding person second personal information on the plurality of subjects, receiving from the first electronic device a first set of answers of the interested person regarding questions presented in a plurality of separate surveys each survey having a different identifiable topic, receiving from the second electronic device a second set of answers of the responding person regarding the questions presented in the plurality of separate surveys, computing a compatibility score using the first and second sets of answers, determining that the interested person and the responding person constitute a potential relationship match based on the compatibility score and based on a separate comparison of the first preferences to the second personal information, transmitting first matching information regarding the responding person to the first electronic device wherein the first matching information excludes any contact information for the responding person, receiving a request from the first electronic device for an in-person meeting between the interested person and the responding person, transmitting a request notification to the second electronic device with second matching information regarding the interested person wherein the second matching information excludes any contact information for the interested person, receiving an affirmative response to the request notification from the second electronic device indicating approval of the in-person meeting by the responding person, after receiving the affirmative response transmitting an invitation to the first electronic device and to the second electronic device to set up the in-person meeting by paying a one-time fee, receiving a first confirmation of the invitation from the first electronic device and a second confirmation of the invitation from the second electronic device, responsive to receipt of the first and second confirmations debiting a first monetary account associated with the interested person by an amount equal to the fee and debiting a second monetary account associated with the responding person by an amount equal to the fee, receiving from the first electronic device a first indication of whether the interested person wants to decide place and time of the in-person meeting, receiving from the second electronic device a second indication of whether the responding person wants to decide place and time of the in-person meeting, selecting only one of the interested person or the responding person as a date initiator based on the first indication, the second indication, a first gender of the interested person and a second gender of the responding person, transmitting a prompt message to a selected one of the first or second electronic devices which is associated with the date initiator wherein the prompt message indicates that the date initiator is to provide proposed date details, receiving proposed date details from the selected one electronic device of the date initiator, transmitting the proposed date details to another of the first or second electronic devices which is not associated with the date initiator, and receiving confirmation from the other electronic device indicating approval of the proposed date details.

8. The computer system of claim 7 wherein the first matching information includes the second set of answers and the second matching information includes the first set of answers.

9. The computer system of claim 7 wherein:
said program instructions further receive a compatibility threshold value selected by the interested person from the first electronic device;
computing the compatibility score includes calculating a percentage of the survey answers from the first set that are identical to the survey answers from the second set; and
determining the potential relationship match includes establishing that the compatibility score is greater than or equal to the compatibility threshold value.

10. The computer system of claim 7 wherein determining the potential relationship match includes establishing that each of the first preferences is satisfied by the second personal information.

11. The computer system of claim 7 wherein:
each of the first and second indications can be affirmative, negative, or neutral as to deciding place and time of the in-person meeting;
the interested person is a male party and the responding person is a female party; and
said selecting selects the female party as the date initiator when the second indication is affirmative, and selects the male party as the date initiator when the second indication is negative.

12. The computer system of claim 7 wherein:
the plurality of subjects comprise factual physical and demographic information including at least age, height, gender, locality, ethnicity and religion; and
the surveys include at least
a personality traits survey having multiple questions,
a social practices survey having multiple questions,
a recreational pursuits survey having multiple questions, and
a future goals survey having multiple questions.

13. A computer program product comprising:
one or more computer readable storage media; and
program instructions collectively residing in said one or more computer readable storage media for facilitating a relationship between an interested person and a responding person by receiving from a first electronic device associated with the interested person first personal information on a plurality of subjects and first preferences relating to at least some of the subjects, receiving from a second electronic device associated with the responding person second personal information on the plurality of subjects, receiving from the first electronic device a first set of answers of the interested person regarding questions presented in a plurality of separate surveys each survey having a different identifiable topic, receiving from the second electronic device a second set of answers of the responding person regarding the questions presented in the plurality of separate surveys, computing a compatibility score using the first and second sets of answers, determining that the interested person and the responding person constitute a potential relationship match based on the compatibility score and based on a separate comparison of the first preferences to the second personal information, transmitting first matching information regarding the responding person to the first electronic device wherein the first matching information excludes any contact information for the responding person, receiving a request from the first electronic device for an in-person meeting between the interested person and the responding person, transmitting a request notification to the second electronic device with second matching information regarding the interested person wherein the second matching information excludes any contact information for the interested person, receiving an affirmative response to the request notification from the second electronic device indicating approval of the in-person meeting by the responding person, after receiving the affirmative response transmitting an invitation to the first electronic device and to the second electronic device to set up the in-person meeting by paying a one-time fee, receiving a first confirmation of the invitation from the first electronic device and a second confirmation of the invitation from the second electronic device, responsive to receipt of the first and second confirmations debiting a first monetary account associated with the interested person by an amount equal to the fee and debiting a second monetary account associated with the responding person by an amount equal to the fee, receiving from the first electronic device a first indication of whether the interested person wants to decide place and time of the in-person meeting, receiving from the second electronic device a second indication of whether the responding person wants to decide place and time of the in-person meeting, selecting only one of the interested person or the responding person as a date initiator based on the first indication, the second indication, a first gender of the interested person and a second gender of the responding person, transmitting a prompt message to a selected one of the first or second electronic devices which is associated with the date initiator wherein the prompt message indicates that the date initiator is to provide proposed date details, receiving proposed date details from the selected one electronic device of the date initiator, transmitting the proposed date details to another of the first or second electronic devices which is not associated with the date initiator, and receiving confirmation from the other electronic device indicating approval of the proposed date details.

14. The computer program product of claim 13 wherein the first matching information includes the second set of answers and the second matching information includes the first set of answers.

15. The computer program product of claim 13 wherein:
said program instructions further receive a compatibility threshold value selected by the interested person from the first electronic device;
computing the compatibility score includes calculating a percentage of the survey answers from the first set that are identical to the survey answers from the second set; and
determining the potential relationship match includes establishing that the compatibility score is greater than or equal to the compatibility threshold value.

16. The computer program product of claim 13 wherein determining the potential relationship match includes establishing that each of the first preferences is satisfied by the second personal information.

17. The computer program product of claim 13 wherein:
each of the first and second indications can be affirmative, negative, or neutral as to deciding place and time of the in-person meeting;
the interested person is a male party and the responding person is a female party; and
said selecting selects the female party as the date initiator when the second indication is affirmative, and selects the male party as the date initiator when the second indication is negative.

18. The computer program product of claim 13 wherein:
the plurality of subjects comprise factual physical and demographic information including at least age, height, gender, locality, ethnicity and religion; and
the surveys include at least
a personality traits survey having multiple questions,
a social practices survey having multiple questions,
a recreational pursuits survey having multiple questions, and
a future goals survey having multiple questions.

19.-22. (canceled)
